(19) United States
(12) Patent Application Publication
(10) Pub. No.: US 2026/0184107 A1
(43) Pub. Date: Jul. 2, 2026

(54) ELASTOMERIC PRODUCT, IN PARTICULAR VEHICLE TYRE

(71) Applicant: Continental Reifen Deutschland GmbH, Hannover (DE)

(72) Inventors: Thomas Kramer, Herford (DE); Nermeen Nabih, Hannover (DE); Michael Schunack, Hannover (DE); Wolfgang Reese, Peine (DE); Cornelia Schmaunz-Hirsch, Wunstorf (DE); Imme Kretschmer, Hannover (DE)

(73) Assignee: Continental Reifen Deutschland GmbH, Hannover (DE)

(21) Appl. No.: 18/837,616

(22) PCT Filed: Feb. 17, 2022
(86) PCT No.: PCT/EP2022/053961

§ 371 Date: Aug. 12, 2024

(51) Int. Cl. B60C 1/00; B60C 9/00; B60C 9/04; C08K 3/04; C08K 3/06; C08K 3/36; C08L 9/00; D02G 3/04; D02G 3/48

(52) U.S. Cl. CPC B60C 1/0041; B60C 9/0042; C08K 3/04; C08K 3/06; C08K 3/36; C08L 9/00; D02G 3/047; D02G 3/48; B60C 2009/0466; C08L 2205/025; C08L 2205/035; C08L 2205/16; C08L 2207/20; C08L 2312/02; D10B 2331/021; D10B 2331/04; D10B 2505/022

(57) ABSTRACT

An elastomeric product, in particular a vehicle tire, wherein the elastomeric product includes filaments of a) recycled polyethylene terephthalate (PET) and b) at least one further material. The further material is selected from the group consisting of b1) recycled polymers and b2) biobased polymers, wherein the recycled polymers b1) are preferably selected from the group consisting of polyesters such as, in particular, polyethylene naphthalate (PEN), polyamides such as, in particular, PA6.6, PA5.6, PA4.6, PA4.10, PA6, PA6.12, PA10.10, PA12.12 and aramids such as, in particular, m-aramid and p-aramid, excluding polyethylene terephthalate (PET) from group b1), and wherein the biobased polymers b2) are preferably selected from the group consisting of polyesters such as, in particular, polyethylene terephthalate (PET) and polyethylene naphthalate (PEN), polyamides such as, in particular, PA6.6, PA5.6, PA4.6, PA4.10, PA6, PA6.12, 20 PA10.10, PA12.12, and aramids such as, in particular, m-aramid and p-aramid, and celluloses such as, in particular, rayon.

The present application is a National Stage Application under 35 U.S.C. § 371 of International Patent Application No. PCT/EP2022/053961 filed on Feb. 17, 2022, the disclosures of which are herein incorporated by reference in their entireties.

The invention relates to an elastomeric product, in particular a vehicle tire, wherein the elastomeric product comprises filaments of a) recycled polyethylene terephthalate (PET) and b) at least one further material.

It is known that elastomeric products have filaments, where the filaments have especially been spun to yarns and serve as strength members in the elastomeric product. The yarns may have been twisted here to reinforcement cords, as in the case of vehicle tires in particular, where the cords are disposed in turn in a multitude within a strength member ply.

In many cases, other industrial rubber articles too, such as belts (including transmission belts) and hoses, have strength members.

The material used for such textile strength members is often polyethylene terephthalate (PET).

One aim here is to resolve, or at least achieve an improvement in, trade-offs between sustainability and performance demands that exist in the selection of the materials for elastomeric products, such as vehicle tires.

DE 102010017107 A1 discloses a reinforcement cord including at least one yarn of recycled PET. The recycled PET may especially come from PET drinks bottles.

It is the object of the present invention to provide an elastomeric product which is further improved in terms of sustainability without this having an adverse effect on the properties of the elastomeric product.

The object is achieved by the elastomeric product as claimed in claim 1.

Preferred configurations of the invention will be apparent from the further claims and from the details that follow.

Embodiments that are referred to below as preferred are combined with features of other embodiments that are referred to as preferred in particularly preferred embodiments. Most particularly preferred are therefore combinations of two or more of the embodiments that are referred to below as particularly preferred. Likewise preferred are embodiments in which a feature of one embodiment that is referred to as preferred to a certain extent is combined with one or more further features of other embodiments that are referred to as preferred to a certain extent.

The invention relates to an elastomeric product, especially vehicle tire, wherein the elastomeric product comprises
filaments of a) recycled polyethylene terephthalate (PET) and
b) at least one further material, wherein the further material is selected from the group consisting of
b1) recycled polymers and b2) biobased polymers, wherein the recycled polymers b1) are preferably selected from the group consisting of polyesters such as, in particular, polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, excluding polyethylene terephthalate (PET) from group b1), and wherein the biobased polymers b2) are preferably selected from the group consisting of polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, and celluloses such as, in particular, rayon.

Because the elastomeric product has the material combination of filaments as set out above, it is of more sustainable composition. At the same time, it is possible by virtue of the material combination mentioned to configure the elastomeric products such that no disadvantages arise with regard to the properties, especially with regard to the profile of requirements in the respectively typical use of the elastomeric products.

The elastomeric product has said filaments of materials a) and b) especially in one or more strength members. In this context, the strength members are especially surrounded by one or more rubber mixtures, also called rubberization mixtures.

The elastomeric product has said filaments of materials a) and b) preferably in a multitude in yarns spun from the filaments, wherein the yarns composed of the filaments serve in particular as strength members.

Here, the filaments of materials a) and b) have been spun collectively in a yarn and/or are present in separate yarns.

Each yarn preferably has a linear density of 100 to 5000 dtex.

The yarns of all embodiments have preferably been twisted to reinforcement cords. Each reinforcement cord preferably has an overall linear density of 100 to 10 000 dtex.

Here, single yarns may have been twisted to form an x1 cord, or a plurality of yarns may have been twisted together, for example two yarns to give an x2 cord or three cords to give an x3 cord.

The yarns and/or reinforcement cords are preferably present in a multitude within a strength member ply.

In this way, the reinforcing properties of the strength members composed of the filaments of materials a) and b) are manifested particularly efficiently.

The elastomeric product, in preferred embodiments, is a vehicle tire.

In the context of the present invention, “vehicle tires” mean pneumatic vehicle tires and all-rubber tires, including tires for industrial and construction site vehicles, truck tires, agricultural tires, car tires and two-wheeler tires.

In further preferred embodiments, the elastomeric product is an industrial rubber article such as, in particular, a conveyor belt, drive belt, other belt, or hose.

Preference is given to an elastomeric product, especially vehicle tire, wherein the elastomeric product has the filaments of a) recycled PET in a first yarn A) and the filaments of b) at least one further material in a second yarn B).

In this way, the elastomeric product is of sustainable composition and, at the same time, the properties of the yarns can be adjusted individually, even with regard to the peculiarities that arise from the respective materials in the production of the yarns from the filaments.

In advantageous embodiments, the yarns A) and B) are collectively end-twisted together to form a reinforcement cord C).

In this way, the properties of the cord, which is what is called a hybrid cord, can be optimally set with regard to the profile of requirements of the elastomeric product, with a synergism arising in particular from the advantages of the properties of the yarns A) made of the filaments of material a) and of the yarns B) made of the filaments of material b).

Preferably, the elastomeric product, especially a vehicle tire, has the reinforcement cords C) in a multitude within a strength member ply.

In this way, the reinforcing properties of the cord composed of the filaments a) and b) are manifested particularly efficiently.

In advantageous embodiments of the invention, yarns A) composed of filaments of a) recycled PET and yarns B) composed of filaments of the further material b), where b) is selected from recycled and biobased polyamides and aramids, more preferably PA6.6 and p-aramid, and rayon, are end-twisted together to form a hybrid cord C).

The specific combination of materials a) and b) results in particularly advantageous properties, as elucidated by way of example hereinafter. The recycled PET a) makes a particular contribution here to the favorable physical properties with comparatively low costs and optimized sustainability.

Preference is given in particular to an elastomeric product wherein the elastomeric product is a vehicle tire, wherein the vehicle tire has reinforcement cords C) in the jointless bandage and b) is preferably selected from recycled and biobased polyamides, more preferably PA6.6. In this context, the polyamides, especially PA6.6, as material b) make a contribution to favorable shrinkage characteristics of the cords C).

In this way, the vehicle tire is particularly optimized with regard to sustainability and costs, and at the same time has excellent properties, especially with regard to demands at high speeds, for example 180 km/h or more.

Preference is also given to an elastomeric product wherein the elastomeric product is a vehicle tire, wherein the vehicle tire has reinforcement cords C) in the carcass ply and b) is preferably selected from recycled and biobased aramids, more preferably p-aramid. Aramids as material b) contribute here to the strength of the cords C).

In this way, the vehicle tire has been optimized particularly with regard to sustainability and costs, and at the same time has excellent properties, especially with regard to service life and driving dynamics.

Preference is also given to an elastomeric product wherein the elastomeric product is a vehicle tire, wherein the vehicle tire has reinforcement cords C) preferably in the carcass ply and b) is rayon. In this context, rayon as material b) makes a particular contribution to thermal stability of the cords C).

In this way, the vehicle tire has been optimized particularly with regard to sustainability and costs, and at the same time has excellent properties, especially with regard to service life.

In further advantageous embodiments, the elastomeric product, especially a vehicle tire, has one or more yarns A) in a first reinforcement cord A′) and one or more yarns B) in a second reinforcement cord B′).

In this context, the yarns composed of the filaments of materials a) and b) are thus present in separate reinforcement cords.

In this way, the materials a) and b) in the respective reinforcement cords may be used in different places in the elastomeric product specifically with regard to the desired properties.

In advantageous embodiments, the elastomeric product, especially a vehicle tire, has the reinforcement cords A′) and B′) in the same component.

In particularly advantageous embodiments, the elastomeric product, especially a vehicle tire, has the reinforcement cords A′) and B′) in different components.

In this way, the elastomeric product has been optimized with regard to sustainability.

At the same time, the materials a) and b) in the respective reinforcement cords may be used in different components of the elastomeric product specifically with regard to the desired properties.

Preference is given in particular to an elastomeric product wherein the elastomeric product is a vehicle tire, wherein the vehicle tire has reinforcement cords A′) in the carcass ply and/or the bead reinforcement and/or the jointless bandage and/or at least one belt ply. In this context, the vehicle tire has reinforcement cords B′) preferably in at least one other component which is preferably likewise a carcass ply, a bead reinforcement, at least one belt ply or a jointless bandage.

Preference is given here to a vehicle tire having reinforcement cords A′) in the jointless bandage and reinforcement cords B′) in the carcass ply and/or the bead reinforcement.

Preference is also given to a vehicle tire having reinforcement cords A′) in the bead reinforcement and reinforcement cords B′) in the carcass ply and/or the jointless bandage.

Preference is also given to a vehicle tire having reinforcement cords A′) in at least one belt ply and reinforcement cords B′) in the carcass ply.

Preference is also given to a vehicle tire having reinforcement cords A′) in the carcass ply and reinforcement cords B′) in the jointless bandage.

For example and with preference, the elastomeric product is thus a vehicle tire, wherein the vehicle tire has reinforcement cords A′) in the carcass ply and reinforcement cords B′) in the jointless bandage, wherein the material b) here is more preferably selected from polyamides, more preferably biobased PA6.6, and aramids, more preferably p-aramid.

For example and with preference, the elastomeric product is additionally a vehicle tire, wherein the vehicle tire has reinforcement cords B′) in the carcass ply and reinforcement cords A′) in at least one other component, especially in the bead reinforcement and/or in the jointless bandage, where the material b) here is more preferably regenerated cellulose, especially rayon.

For example and with preference, the elastomeric product is additionally a vehicle tire, wherein the vehicle tire has reinforcement cords A′) in the jointless bandage and reinforcement cords B′) in at least one other component, especially in the bead reinforcement and/or the carcass ply, wherein the material b) here is more preferably selected from polyamides, more preferably biobased PA6.6.

In further advantageous embodiments of the invention, the elastomeric product is a vehicle tire having the above-described reinforcement cords C) composed of yarns A) and B) in at least one first component and having reinforcement cords A′) having at least one yarn A) and/or reinforcement cords B′) having at least one yarn B) in at least one other component.

Preference is given in particular to an elastomeric product, wherein the elastomeric product is a vehicle tire, wherein the vehicle tire has reinforcement cords C) in the jointless bandage and b) in the reinforcement cords C) is more preferably selected from recycled and biobased polyamides, most preferably PA6.6; and the vehicle tire additionally has reinforcement cords B′) at least in the carcass ply, where b) in the reinforcement cords B′) is more preferably regenerated cellulose, especially rayon, or biobased PA6.6.

Preference is also given to an elastomeric product, wherein the elastomeric product is a vehicle tire, wherein the vehicle tire has reinforcement cords C) in the carcass ply and b) in the reinforcement cords C) is more preferably selected from recycled and biobased aramids, most preferably p-aramid; and the vehicle tire additionally has reinforcement cords B′) at least in the jointless bandage, where b) in the reinforcement cords B′) is more preferably selected from polyamides, more preferably biobased PA6.6, and aramids, more preferably p-aramid.

The materials a) and b) are elucidated in detail hereinafter.

Material a) is recycled polyethylene terephthalate (PET).

The further material b) is selected from the group consisting of
b1) recycled polymers and b2) biobased polymers, wherein the recycled polymers b1) are preferably selected from the group consisting of
polyesters such as, in particular, polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, excluding polyethylene terephthalate (PET) from group b1), and wherein the biobased polymers b2) are preferably selected from the group consisting of polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, and celluloses such as, in particular, rayon.

The reason why PET is excluded from group b1) is that recycled PET is already present as material a) and, according to the invention, the elastomeric product includes a combination of filaments of a) recycled PET and filaments of b) at least one further sustainable material.

Recycled PET (material a)) and recycled polymers (material of subgroup b1)) are known in general terms to the person skilled in the art.

The expression “recycled polymer” in the context of the present invention means a polymer that has been obtained by at least one recycling process.

This and the further details relating to recycling are also applicable to PET.

The recycling process may be any of the recycling processes known to the person skilled in the art, such as, in particular, chemical and/or mechanical recycling.

Starting materials for recycling are especially bottles, clothing and yarn wastes.

Mechanical recycling processes in the context of the invention also include thermal treatments such as, in particular, remelting.

Chemical recycling in the context of the present invention is any kind of chemical processing of wastes and subsequent recovery of products or precursor materials therefrom. This can also mean complete chemical degeneration to molecules from which the physical source, i.e. the chemical nature of the waste, is no longer immediately apparent, and subsequent synthesis from these molecules to the extent of polymers that are then used in the process of the invention as recycled polymer in the textile strength member.

In addition, it is also possible to recycle industrial yarn wastes and use them as material a) or b1), as in particular in the case of PA 6.6.

In this context, depending on the nature and similarity of the yarn wastes to the materials required, chemical and/or mechanical recycling may be viable.

Recycled PET that has especially been produced by mechanical recycling from bottles differs from virgin PET by additions such as, in particular, by the content of isophthalic acid (IPA). These additions, especially of IPA, are present, for example and in particular, in PET bottles.

While virgin PET has an isophthalic acid content of 0% by weight, the IPA content in recycled PET may be up to 5% by weight.

Preference is therefore given to an elastomeric product, especially vehicle tire, wherein the filaments of a) recycled PET comprise 0.12% to 5% by weight, especially 0.12% to 2.2% by weight, of isophthalic acid (IPA).

The weight figures in percent (% by weight) are based here on the filaments and hence, in the elastomeric product of the invention, on the unrubberized and unpretreated form, in particular the unrubberized and unpretreated, i.e. especially undipped, yarn.

Recycled PET that has been obtained by mechanical recycling from yarn wastes additionally has a greater polydispersity index compared to reference yarns that have not been recycled.

Preference is additionally given to an elastomeric product, especially vehicle tire, wherein the filaments of a) recycled PET have a crystallization level of 45% to 53.5%.

The crystallization level is determined to ASTM D1505 as follows: A density gradient column is first used to ascertain the yarn density. Subsequently, the crystallization level is calculated by interpolation using the literature values for the density of 100% amorphous and 100% crystalline PET specified hereinafter. The density of 100% amorphous PET is 1.333 g/cm³, while that of 100% crystalline PET is 1.455 g/cm³.

With such a crystallization level, the filaments, especially in the form of yarns and hence strength members, have the necessary properties with regard to elongation and shrinkage characteristics, especially for the high demands in the case of use in the carcass ply of vehicle tires.

Preference is additionally given to an elastomeric product, especially vehicle tire, wherein the filaments of a) recycled PET comprise 10% to 100% by weight, preferably 30% to 100% by weight, more preferably 50% to 100% by weight, of recycled PET.

In preferred embodiments, the recycled PET is based entirely, i.e. to an extent of 100% by weight, on recycled PET. In this way, the elastomeric product of the invention has been optimized particularly with regard to sustainability, with simultaneously very good properties.

In further preferred embodiments, the recycled PET is also based to an extent of 1% to 90% by weight on recycled PET and to an extent of 10% to 99% by weight on mineral oil-based PET. In this way, the elastomeric product of the invention has been optimized particularly with regard to the balance of sustainability with simultaneously very good properties, where it is simultaneously possible by controlled selection of the proportion of recycled PET to adjust the properties of the products produced as required.

Strength members comprising filaments of a) recycled PET are preferably obtained by the following process, wherein the process comprises at least the following individual process steps:
a01) providing at least one product made of PET, wherein the product is especially selected from bottles and clothing and yarn wastes;
a02) mechanically and/or chemically recycling the PET product from step a01);
a03) forming the recycled PET from step a02) to filaments, wherein the filaments are preferably processed, especially spun, to a yarn;
a04) processing the filaments obtained in step a03), preferably in the form of a yarn, to give a strength member, especially a reinforcement cord.

The process described is also performable analogously for the recycled polymers of subgroup b1).

Strength members comprising filaments of b1) recycled polymers may alternatively and preferably be obtained by the following process, wherein the process comprises at least the following individual process steps:
a31) providing wastes such as, in particular, used tires, yarn wastes, and wastes from the manufacture of semifinished products from vehicle tires and other industrial rubber articles;
a32) pyrolyzing the wastes from step a31) to obtain a pyrolysis oil containing at least one chemical starting substance;
a33) converting the chemical starting substance to at least one monomer, where the monomer is preferably selected from the group consisting of p-phenylenediamine, tetramethylenediamine, pentamethylenediamine, hexamethylenediamine, decamethylenediamine, terephthalic acid, monoethylene glycol, adipic acid, succinic acid, sebacic acid and polycondensable derivatives of these monomers, and polymerizing the monomer to a recycled polymer;
a34) forming the recycled polymer to filaments, wherein the filaments are preferably processed, especially spun, to a polymer yarn;
a35) processing the filaments obtained in step a34), preferably in the form of a yarn, to give a strength member, especially a reinforcement cord.

“Wastes” in the context of the present invention, in principle, mean any wastes suitable as starting substances for the process steps.

The wastes are preferably used tires, yarn wastes, especially from yarn production, and wastes from the manufacture of semifinished products from vehicle tires and other industrial articles.

Particular preference is given to used tires and yarn wastes.

The monomers mentioned with preference are especially those from which polymers such as polyethylene terephthalate (PET) or nylon-6,6, for example, can be obtained by polycondensation.

What is meant by “polycondensable derivatives of these monomers” is monomers that have a base structure similar to the monomers mentioned and lead to the same target polymers by analogous polycondensation.

In the case of PET as “target polymer”, one monomer is terephthalic acid.

An example of a polycondensable derivative thereof would be methyl terephthalate.

In particular and by way of example, polycondensable derivatives are thus selected from carboxylic esters, preferably alkyl carboxylates, preferably selected from the group consisting of alkyl terephthalates, alkyl adipates, alkyl succinates, alkyl sebacates.

The alkyl radical of all alkyl carboxylates mentioned is, for example with preference, selected from the group consisting of methyl, ethyl, propyl, butyl, pentyl, hexyl and cyclohexyl, more preferably methyl, ethyl, propyl.

In further preferred embodiments of the invention, the monomer in step a33) is selected from the group consisting of p-phenylenediamine, tetramethylenediamine, pentamethylenediamine, hexamethylenediamine, decamethylenediamine, terephthalic acid, monoethylene glycol, adipic acid, succinic acid and sebacic acid.

In advantageous embodiments of the invention, the material b) used is a recycled polymer b1), more preferably recycled PA6.6, especially from yarn wastes.

In advantageous embodiments, the elastomeric product has the filaments of a) recycled PET in the form of a PET yarn A), which is what is called a “regular PET yarn”.

“Regular PET yarn” in the context of the present invention means a yarn having a hot shrinkage of not less than 8% and an elongation at 45 N of not less than 0.0056%/den, with linear filament densities of less than 5 den.

In advantageous embodiments, the elastomeric product has the filaments of a) recycled PET in the form of an HMLS PET yarn A), where the HMLS yarn has a hot shrinkage of less than 8% and an elongation at 45 N of less than 0.0056%/den in the case of linear filament densities of less than 5 den.

The object underlying the invention is achieved particularly efficiently by the selection of filaments a) in the form of recycled HMLS PET yarn.

The abbreviation “HMLS” is familiar to the person skilled in the art and means “high modulus low shrinkage”. An “HMLS yarn” is thus understood to mean a high-modulus low-shrinkage yarn. In the context of the present invention, an HMLS yarn is defined in that, as set out above, it has hot shrinkage of less than 8% and elongation at 45 N of less than 0.0056%/den in the case of linear filament densities of less than 5 den

The yarn of HMLS-PET preferably has hot shrinkage of 4% to 8%, and elongation at 45 N of 0.002%/den to 0.0056%/den, with linear filament densities of less than 5 den, more preferably 3 to 5 den.

The elastomeric product is preferably a vehicle tire including the HMLS PET yarn A) in the carcass ply. As a result, flatspot characteristics (=reversible plastic flaking in the ground contact patch on parking) are optimized and extensive sidewall indentations are avoided.

HMLS PET yarns or reinforcement cords made from HMLS PET yarns containing recycled PET to an extent of 10% to 100% by weight are preferably obtained by the following process, wherein the process comprises at least the following individual process steps:
a10) providing PET chips comprising 100% by weight of recycled PET from PET bottles or other PET products, and optionally providing chips of virgin, i.e. mineral oil-based, PET;
a11) pre-crystallization, crystallization and solid-state polymerization of the PET from step a10) to give high-viscosity PET chips having an intrinsic viscosity of 0.85 to 1.15 dl/g;
a12) drying, optionally mixing the chips of recycled PET with chips of virgin PET, giving PET chips comprising 10 to 100% by weight of chips of recycled PET, melting and extruding the PET chips for the yarn spinning, then yarn spinning by means of a spinneret comprising a reheater having a buffer zone for the high-viscosity PET chips from step a11), and stepwise cooling of the unstretched yarn, wherein the water content of the chips after drying is less than 30 ppm, the temperature of the reheater beneath the spinneret is 280 to 350° C. and the length of the buffer zone beneath the reheater during the stepwise cooling is 20 to 100 mm;
a13) oiling, drawing, heat-setting and winding after stepwise cooling in step a12) to obtain a PET yarn composed of filaments consisting wholly or partly of recycled PET, wherein the resultant PET yarn is an HMLS PET yarn having a hot shrinkage of less than 8% and an expansion at 45 N of less than 0.0056%/den in the case of linear filament densities of less than 5 den;
a14) optionally processing the yarn obtained in step a13) to give a reinforcement cord.

Preference is thus also given to an elastomeric product, especially vehicle tire, wherein the elastomeric product
has the filaments of a) recycled PET in the form of an HMLS PET yarn A), wherein the HMLS yarn has been produced by a process comprising at least process steps a10) to a14).

The hot shrinkage of yarns in the context of the present invention is determined by means of the hot shrinkage method to ASTM D885. The test conditions are: temperature 177° C., load 0.05 g/den, duration 10 min.

Elongation at 45 N is determined in the context of the present invention by means of an Instron tensile tester to ASTM D885: Instron 5564 instrument, clamp: C-clamp, 2714-004 with pneumatic activation, load capacity 1 kN (1 kilonewton), test conditions: gauge length 250 mm, cross-head speed 300 mm/minute, pre-tension 0.05 gf/den (gram force per denier), air pressure 0.4 to 0.6 MPa, conditioning of the samples before the test: 24 hours at 24±(plus/minus) 2° C., 55±5% air humidity.

Intrinsic viscosity is determined in the context of the present invention by means of an Ubbelohde capillary viscometer to ASTM D4603.

Pre-crystallization, crystallization and solid-state polymerization (SSP) in step b) achieve further polymerization and hence a reduction in the proportion of shorter polymer molecules, which achieves molecular chain growth. This results in elevated intrinsic viscosity. This improves the drawability of the material, with an improvement in the tensile strength and modulus (stiffness) of the yarn as well.

By combining the pre-crystallization and crystallization with the temperature of the reheater beneath the spinneret of 280 to 350° C. and the length of the buffer zone under the reheater during the stepwise cooling of 20 to 100 mm in step a12), it is possible to adjust the crystallization rate in such a way as to choose a high spinning speed and a high tension rate in the spinning process.

Moreover, the frequency of filament and yarn breakage is reduced, which results in a yarn having high tensile strength and high modulus.

Solid-state polymerization (SSP) is a process in which the crude PET chips are placed in a reactor and heated in order to polymerize. This increases molecular chain length and intrinsic viscosity. The intrinsic viscosity of recycled PET chips is 0.55 to 0.75 dl/g.

Solid-state polymerization is also referred to as solid-phase condensation, since the withdrawal of water results in condensation.

The expression “biobased polymer” of subgroup b2) in the context of the present invention means a polymer which, in physical terms, is formed entirely or at least partly from monomers that have been obtained from biomasses.

In the context of the present invention, what is meant by “produced entirely from biomasses” is that 100% by weight of the starting monomers has been obtained directly in physical form from biomasses.

In advantageous embodiments of the invention, the biobased polymer b2) has been produced entirely, i.e. to an extent of 100% by weight, from monomers from biomasses.

In this way, the elastomeric product of the invention has been optimized particularly with regard to sustainability, with simultaneously very good properties.

In the context of the present invention, what is meant by “produced at least partly from biomasses” is that more than 0% by weight of the starting monomers has been obtained directly in physical form from biomasses.

In further advantageous embodiments of the invention, the biobased polymer b2) has been produced partly, i.e. to an extent of more than 0% by weight and less than 100% by weight, from monomers from biomasses, especially when some of the parent monomers of the polymer are not obtainable via biomasses.

In this way, the elastomeric product of the invention has been optimized with regard to the flexibility and sustainability required, depending on the availability of starting materials, with simultaneously very good properties.

In preferred embodiments, 10% to 100% by weight, more preferably 30% to 100% by weight, of the starting monomers are produced from biomasses. This means that, in these preferred embodiments, the biobased polymer is based to an extent of 10% to 100% by weight, more preferably to an extent of 30% to 100% by weight, on the polymerization of starting monomers produced from biomasses.

As is known to the person skilled in the art, the proportion of the biobased materials, i.e. the proportion derived from renewable raw materials in the polymer, can be determined in accordance with ASTM D6866 (C-14 method).

More preferably, the biobased polymer is selected from the group consisting of polyethylene terephthalate (PET), nylon-6,6 (PA 6.6), polyamide (PA 5.6), nylon-4,6 (PA 4.6), nylon-4,10 (PA 4.10) and aramid.

PET is based on the polymerization, especially polycondensation, of the starting monomers terephthalic acid and monoethylene glycol (MEG, also ethanediol).

The biobased PET is preferably based to an extent of 30% to 100% by weight on the polymerization of starting monomers produced from biomasses.

In advantageous embodiments, both monomers of the biobased PET are obtained not from mineral oil but from biomasses.

In further advantageous embodiments, at least monoethylene glycol is obtained from biomasses, especially from plant raw materials, for example sugarcane or molasses.

Nylon-6,6 (PA 6.6) is based on polymerization, especially polycondensation, of the starting monomers hexamethylenediamine and adipic acid.

The biobased PA 6.6 is preferably based to an extent of 50% to 100% by weight on the polymerization of starting monomers produced from biomasses.

In advantageous embodiments, both monomers of the biobased PA6.6 are obtained not from mineral oil but from biomasses.

Nylon-5,6 is based on polymerization, especially polycondensation, of the starting monomers pentamethylenediamine (1,5-diaminopentane) and adipic acid.

In advantageous embodiments, both monomers of the biobased PA5.6 are obtained not from mineral oil but from biomasses.

In further advantageous embodiments, at least pentamethylenediamine is obtained not from mineral oil but from biomasses.

Nylon-4,6 is based in particular on polymerization, especially polycondensation, of the starting monomers hexamethylenediamine and succinic acid.

In advantageous embodiments, both monomers of the biobased PA4.6 are obtained not from mineral oil but from biomasses.

In further advantageous embodiments, at least succinic acid is obtained not from mineral oil but from biomasses.

Nylon-4,10 is based on polymerization, especially polycondensation, of the starting monomers tetramethylenediamine and sebacic acid.

In advantageous embodiments, both monomers of the biobased PA4.10 are obtained not from mineral oil but from biomasses.

In further advantageous embodiments, at least tetramethylenediamine is obtained not from mineral oil but from biomasses.

In further advantageous embodiments, at least sebacic acid is obtained not from mineral oil but from biomasses.

In advantageous embodiments, the biobased polymer is biobased aramid.

In preferred embodiments, the biobased aramid is based to an extent of 50% to 100% by weight on the polymerization, especially polycondensation, of starting monomers produced from biomasses (monomers from biomasses).

In preferred embodiments, the biobased aramid is based entirely, i.e. to an extent of 100% by weight, on the polymerization, especially polycondensation, of monomers from biomasses.

In advantageous embodiments of the invention, the material b) used is a biobased polymer b2), more preferably biobased PA6.6 and/or p-aramid.

Strength members comprising filaments of b2) biobased polymers are preferably obtained by the following process, wherein the process comprises at least the following individual process steps:
b21) producing or providing a starting composition comprising starting monomers produced entirely or at least partly from biomass;
b22) polymerizing the starting monomers present in the starting composition to give a biobased polymer;
b23) forming the biobased polymer to filaments, wherein the filaments are preferably processed, especially spun, to a biobased polymer yarn;
b24) processing the filaments obtained in step b23), preferably in the form of a yarn, to give a strength member, especially a reinforcement cord.

Preference is given to an elastomeric product, especially vehicle tire, wherein the further material b) is selected from recycled PA6.6, biobased PA4.10, biobased PA4.6, biobased p-aramid and biobased PET.

As set out at the outset, particular preference is given to an elastomeric product, especially a vehicle tire, wherein the elastomeric product has the filaments of a) recycled PET in a first yarn A) and the filaments of b) at least one further material in a second yarn B).

In this context, the yarns A) and B) are preferably surrounded by different or the same rubber mixture, called “rubberization mixture” hereinafter.

The yarns A) and B) are preferably present here
in the cords C) described, which is a hybrid cord composed of at least one yarn A) and at least one yarn B),
or the cords A′) and B′).

The rubberization mixture of the yarns A) and/or B) preferably contains at least one constituent selected from the group consisting of biobased fillers, preferably silica produced from rice husk ash, recycled fillers, preferably pyrolysis carbon blacks, biobased polymers, preferably biobased polybutadiene, and wherein the rubberization mixture is preferably essentially free of resorcinol.

In this way, the sustainability and benignity in terms of the environment and health of the process of the invention and of the composite material produced and of the elastomeric product produced are increased further, where the physical properties of the composite material produced and of the elastomeric product produced are simultaneously at a very good level.

Pyrolysis carbon blacks are known to the person skilled in the art, for example from US 2010249353A1, and are obtained by pyrolysis of used tires in the absence of oxygen.

Pyrolysis carbon black differs from industrial carbon black, especially the ASTM carbon blacks such as N660, in properties including a higher ash content and simultaneously lower content of polycyclic aromatic hydrocarbons (PAH).

Industrial carbon blacks have a high proportion of polycyclic aromatic hydrocarbons (PAH). Industrial carbon blacks have a PAH content of greater than 200 mg/kg.

The PAH content of the pyrolysis carbon blacks used in the context of the present invention is preferably less than 50 ppm (mg/kg), more preferably less than 40 ppm, most preferably less than 30 ppm, preferably in turn less than 10 ppm. The lower limit is in the region of 0.1 mg/kg, which constitutes the detection limit for PAH. In principle, the PAH content should be as low as possible.

The PAH content is determined to ASTM D-5186.

The pyrolysis carbon blacks used in the context of the present invention preferably have an ash content of 5% to 30% by weight, more preferably 10% to 30% by weight, most preferably 10% to 20% by weight. In a preferred embodiment of the invention, the ash content is 15% to 20% by weight.

The ash content is based solely on pyrolysis carbon black and is determined by thermogravimetric analysis (TGA) to ASTM D1506 of the pyrolysis carbon black.

“Silica produced from rice husk ash” is also known to those skilled in the art as “rice husk ash silica” (RHAS).

This is silica obtained from the inorganic combustion residues (ash) of rice husks. The ash obtained from rice husks comprises a relatively high silica proportion of more than 80% by weight and is therefore particularly suitable for obtaining silica.

The silica produced from rice husk ash present in the rubberization mixture preferably has a nitrogen surface area (BET surface area) (to DIN ISO 9277 and DIN 66132) of 35 to 400m²/g, more preferably of 35 to 350 m²/g, even more preferably of 75 to 320 m²/g and even more preferably in turn of 120 to 235 m²/g, and a CTAB surface area (to ASTM D 3765) of 30 to 400 m²/g, more preferably of 30 to 330 m²/g, even more preferably of 70 to 300 m²/g and even more preferably in turn of 110 to 230 m²/g.

What is meant by biobased polymers, preferably biobased polybutadiene, analogously to the above remarks, is that at least one monomer of the polymer of the rubberization mixture is obtained from biomasses.

The rubberization mixture is preferably essentially free of resorcinol.

This is especially and preferably achieved by selection of one or more of the following options:
I) the rubberization mixture is free of reinforcer resins and contains 0 phr of methylene acceptors and methylene donors, which includes freedom of the mixture from resorcinol;
II) the rubberization mixture is free of methylene acceptors and contains 0 phr of methylene acceptors, which includes freedom of the mixture from resorcinol;
III) the rubberization mixture contains a suitable substance as resorcinol substitute in combination with a methylene donor, such as preferably and by way of example at least one novolak resin having alkylurethane units, and an etherified melamine resin, as described, for example, in EP 2 432 810 B1 or WO 2021197648A1.

The rubberization mixture may otherwise be any suitable rubberization mixture known to the person skilled in the art for ensheathing of strength members, especially textile strength members. The rubberization mixture preferably contains at least one diene rubber, especially if biobased polymer, especially polybutadiene, is not already present in the rubberization mixture.

The presence of at least one diene rubber means that the rubberization mixture is in particular sulfur-vulcanizable.

All the described strength members composed of filaments a) and b) are preferably treated in a known manner before ensheathing with one or more rubberization mixtures.

This preferably involves, in particular, activation of adhesion of the strength members.

For this purpose, the formed strength members are processed further by means of a dip. As a result of this, the strength member, especially the yarn or the cord, is given ideal physical properties and optimized adhesion capacity to the rubberization mixture applied later.

More particularly, the dip may comprise a pre-dip and an RFL (resorcinol-formaldehyde latex) dip known in the prior art or an RFL-free alternative which is benign in respect of the environment and health, as described, for example, in DE 102014211362A1, WO 2019015792A1, EP 3702521A1, EP 3702522 A1 or EP 3702523A1.

The modification of adhesion by means of a dip may thus especially comprise 1-bath or 2-bath (pre-dip and dip) methods known in the prior art.

During the dipping method, devices and conditions known in the art are used successively, such as dip solution tanks, tension zones and ovens. The strength member is extended here by 0% to 8%, especially 0% to 3%.

Strength members comprising filaments of a) recycled PET, in advantageous embodiments, are treated here by means of an RFL dip.

Otherwise, the elastomeric product, especially vehicle tire, is produced in a manner known to the person skilled in the art with apparatuses known to the person skilled in the art.

In this context, in particular, an unvulcanized blank, especially of an unvulcanized vehicle tire, having filaments of materials a) and b), including all the embodiments described, is first provided by laying the corresponding components, which comprise unvulcanized rubber mixtures, one on top of another. Subsequently, the blank is vulcanized.

In advantageous developments of the invention, the elastomeric product contains recycled steel in the form of strength members. For example, the elastomeric product here is a vehicle tire containing, in a component, for example in at least one belt ply and/or in at least one bead core and/or at least in the carcass ply, recycled steel in the form of strength members.

“Recycled steel” in the context of the present invention means steel that has been produced entirely, i.e. to an extent of 100% by weight, or at least partly, i.e. to an extent of 1% to 99.99% by weight, preferably 50% to 99.99% by weight, by a method of recycling steel (used steel).

In this way, the elastomeric product has been further optimized with regard to sustainability.

The invention is further elucidated hereinafter with reference to some illustrative and particularly advantageous configurations.

### Example 1

First of all, textile strength members containing filaments of a) recycled PET are produced in the form of recycled HMLS PET yarn. For this purpose, starting materials provided in step a10) are PET chips comprising 100% by weight of recycled PET from PET bottles or other PET products, and the process is conducted according to steps a11) to a14), including the solid-phase polymerization as described above.

The raw PET chips, in step a11), are pre-crystallized at a temperature of 150 to 180° C. for 0.5 to 1.5 hours and then crystallized at a temperature of 200 to 230° C. for 4 to 6 hours and finally left to react in an SSP reactor at a wall temperature of 200 to 220° C. for 30 to 35 hours.

The entire system of apparatuses is operated in a nitrogen atmosphere, where the oxygen content of the nitrogen is kept at 30 to 70 ppm and the dew point is preferably lower than −70° C. (lower than minus 70° C.).

The chips, in step a12), are processed to an unstretched yarn A) and then, in step a13), processed to an HMLS yarn, where the yarn has a hot shrinkage of 2.3% and an elongation at 45 N of 0.0008%/den at linear filament densities of less than 5 den.

The yarn A) is produced with a linear density of 1100 dtex, and 2 yarns in each case are end-twisted with one another to give an ×x2 cord A′).

The cords A′) are then pretreated with a preliminary dip. The preliminary dip at the following composition: 95.26% by weight (percent by weight) of water, 0.90% by weight of Denacol EX313 (an epoxy compound) and 3.84% by weight of Grilbond IL-6 (a polyisocyanate compound). Subsequently, the pre-dipped cords are heat-treated at 210 to 250° C.

Thereafter, the cords are treated for activation of adhesion by means of an RFL dip known in the prior art. Subsequently, the dipped cords are heat-treated at 170 to 250° C.

Subsequently, the adhesion-activated textile strength member is fully embedded into a crosslinkable rubberization mixture. The crosslinkable rubberization mixture contains, inter alia, 100 phr of diene rubbers, including at least 50 phr of polyisoprene, and 30 phr of pyrolysis carbon black.

As part of a customary vulcanization system, the crosslinkable rubberization mixture additionally comprises 2.4 phr of sulfur and at least one novolak resin having alkylurethane units, and an etherified melamine resin and additionally customary further constituents.

The unit “phr” (parts per hundred parts of rubber by weight) used in the context of the present invention is the standard unit of quantity for mixture recipes in the rubber industry. The dosage of the parts by weight of the individual substances is always based here on 100 parts by weight of the total mass of all rubbers present in the mixture, which accordingly adds up to 100.

The strength members that have been rubberized as described above are provided as a vulcanizable strength member ply, specifically in the form of a carcass ply.

Moreover, a vulcanizable strength member ply as jointless bandage is provided as a further component, where the jointless bandage contains filaments of material b), specifically in the form of x2 cords B′) composed of yarns B) having a linear yarn density of 470 dtex, where material b) is more preferably selected from polyamides, most preferably biobased PA6.6. The 470 x2 cords of PA6.6 are likewise rubberized with a rubberization mixture containing, inter alia, 100 phr diene rubbers, of which at least 50 phr is polyisoprene, and 30 phr of pyrolysis carbon black. The rubberization mixture of the jointless bandage may differ here from the rubberization mixture of the carcass ply, and the person skilled in the art chooses customary constituents with regard to the respective components and the resulting requirements.

The two unvulcanized components are combined with other components to give an unvulcanized car tire blank.

The unvulcanized tire blank is then used to obtain, by vulcanization under customary conditions, a vehicle tire comprising, in the carcass ply, filaments of a) recycled PET and, in the jointless bandage, filaments of b) the further sustainable material, for example of biobased PA6.6.

The illustrative car tire thus obtained is a particularly favorable embodiment of a product of the invention in which the advantages of the present invention are manifested to a particularly significant degree. The car tire is produced in a sustainable manner and in a manner particularly benign to health and the environment, and is of particularly sustainable composition, being simultaneously notable for optimal service life in traveling operation.

1. An elastomeric product, in particular vehicle tire, wherein the elastomeric product comprises
filaments of a) recycled polyethylene terephthalate (PET) and
b) at least one further material, wherein the further material is selected from the group consisting of
b1) recycled polymers and b2) biobased polymers, wherein the recycled polymers b1) are preferably selected from the group consisting of
polyesters such as, in particular, polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, excluding polyethylene terephthalate (PET) from group b1), and wherein the biobased polymers b2) are preferably selected from the group consisting of polyesters such as, in particular, polyethylene terephthalate (PET) and polyethylene naphthalate (PEN),
polyamides such as, in particular, PA6.6, PA5.6, PA4.6, PA4.10, PA6, PA6.12, PA10.10, PA12.12, and
aramids such as, in particular, m-aramid and p-aramid, and celluloses such as, in particular, rayon,
wherein the elastomeric product has said filaments of materials a) and b) preferably in a multitude in yarns spun from the filaments, wherein the yarns composed of the filaments serve in particular as strength members.

2. The elastomeric product, especially vehicle tire, as claimed in claim 1, wherein the elastomeric product has the filaments of a) recycled PET in a first yarn A) and the filaments of b) at least one further material in a second yarn B).

3. The elastomeric product, especially vehicle tire, as claimed in claim 2, wherein the yarns A) and B) are collectively end-twisted together to form a reinforcement cord C).

4. The elastomeric product as claimed in claim 3, wherein the elastomeric product is a vehicle tire, wherein the vehicle tire has reinforcement cords C) in the jointless bandage and b) is preferably selected from recycled and biobased polyamides, more preferably PA6.6.

5. The elastomeric product as claimed in claim 3, wherein the elastomeric product is a vehicle tire, wherein the vehicle tire has reinforcement cords C) in the carcass ply and b) is preferably selected from rayon and recycled and biobased aramids, more preferably p-aramid.

6. The elastomeric product, especially vehicle tire, as claimed in claim 2, wherein the elastomeric product has one or more yarns A) in a first reinforcement cord A′) and one or more yarns B) in a second reinforcement cord B′).

7. The elastomeric product, especially vehicle tire, as claimed in claim 6, wherein the elastomeric product has the reinforcement cords A′) and B′) in the same component.

8. The elastomeric product, especially vehicle tire, as claimed in claim 6, wherein the elastomeric product has the reinforcement cords A′) and B′) in different components, wherein the elastomeric product is preferably a vehicle tire, wherein the vehicle tire has reinforcement cords A′) preferably in the carcass ply and/or the bead reinforcement and/or the jointless bandage and/or at least one belt ply, and reinforcement cords B′) preferably in at least one other component which is preferably likewise a carcass ply, a bead reinforcement, at least one belt ply and/or a jointless bandage.

9. The elastomeric product as claimed in claim 8, wherein the elastomeric product is a vehicle tire having reinforcement cords A′) in the jointless bandage and reinforcement cords B′) in the carcass ply and/or the bead reinforcement.

10. The elastomeric product as claimed in claim 8, wherein the elastomeric product is a vehicle tire having reinforcement cords A′) in the bead reinforcement and reinforcement cords B′) in the carcass ply and/or the jointless bandage.

11. The elastomeric product as claimed in claim 8, wherein the elastomeric product is a vehicle tire having reinforcement cords A′) in at least one belt ply and reinforcement cords B′) in the carcass ply.

12. The elastomeric product as claimed in claim 8, wherein the elastomeric product is a vehicle tire having reinforcement cords A′) in the carcass ply and reinforcement cords B′) in the jointless bandage.

13. The elastomeric product, especially vehicle tire, as claimed in claim 1, wherein the elastomeric product
has the filaments of a) recycled PET in the form of an HMLS PET yarn A), where the HMLS yarn has a hot shrinkage of less than 8% and an elongation at 45 N of less than 0.0056%/den in the case of linear filament densities of less than 5 den.

14. The elastomeric product, especially vehicle tire, as claimed in claim 1, wherein the filaments of a) recycled PET comprise 10% to 100% by weight, preferably 30% to 100% by weight, more preferably 50% to 100% by weight, of recycled PET.

15. The elastomeric product, especially vehicle tire, as claimed in claim 1, wherein the filaments of a) recycled PET comprise 0.12% to 5% by weight, especially 0.12% to 2.2% by weight, of isophthalic acid (IPA).

16. The elastomeric product, especially vehicle tire, as claimed in claim 1, wherein the filaments of a) recycled PET have a degree of crystallization of 45% to 53.5%.

17. The elastomeric product, especially vehicle tire, as claimed in claim 1, wherein the elastomeric product
has the filaments of A) recycled PET in the form of an HMLS PET yarn A), wherein the HMLS yarn has been produced by at least the following process steps:
a10) providing PET chips comprising 100% by weight of recycled PET from PET bottles or other PET products, and optionally providing chips of virgin PET;
a11) pre-crystallization, crystallization and solid-state polymerization of the PET from step a10) to give high-viscosity PET chips having an intrinsic viscosity of 0.85 to 1.15 dl/g;
a12) drying, optionally mixing the chips of recycled PET with chips of virgin PET, giving PET chips comprising to an extent of 10 to 100% by weight of chips of recycled PET, melting and extruding the PET chips for the yarn spinning, then yarn spinning by means of a spinneret comprising a reheater having a buffer zone for the high-viscosity PET chips from step a11), and stepwise cooling of the unstretched yarn, wherein the water content of the chips after drying is less than 30 ppm, the temperature of the reheater beneath the spinneret is 280 to 350° C. and the length of the buffer zone beneath the reheater during the stepwise cooling is 20 to 100 mm;
a13) oiling, drawing, heat-setting and winding after stepwise cooling in step a12) to obtain an HMLS PET yarn having a hot shrinkage of less than 8% and an expansion at 45 N of less than 0.0056%/den in the case of linear filament densities of less than 5 den;
a14) optionally processing the yarn obtained in step a13) to give a reinforcement cord.

18. The elastomeric product, especially vehicle tire, as claimed in claim 2, wherein the further material b) is selected from recycled PA6.6, biobased PA4.10, biobased PA4.6, biobased p-aramid and biobased PET.

19. The elastomeric product, especially vehicle tire, as claimed in claim 2, wherein the elastomeric product has the filaments of a) recycled PET in a first yarn A) and the filaments of b) at least one further material in a second yarn B), wherein the yarns A) and B) are surrounded by different or the same rubberization mixture,
wherein the rubberization mixture of the yarns A) and/or B) contains at least one constituent selected from the group consisting of biobased fillers, preferably silica produced from rice husk ash, recycled fillers, preferably pyrolysis carbon blacks, biobased polymers, preferably biobased polybutadiene, and wherein the rubberization mixture is preferably essentially free of resorcinol.
